(19) United States
(12) Patent Application Publication
(10) Pub. No.: US 2012/0303534 A1
(43) Pub. Date: Nov. 29, 2012

(54) SYSTEM AND METHOD FOR A SECURE TRANSACTION

(75) Inventors: Alexander KELLER, Tuntenhausen (DE); Ilan SIKARY, Munchen (DE)

(73) Assignee: TOMAXX GMBH, Aschheim (DE)

(21) Appl. No.: 13/482,607

(22) Filed: May 29, 2012

Related U.S. Application Data
(60) Provisional application No. 61/490,634, filed on May 27, 2011.

(51) Int. Cl. G06Q 20/40; G06Q 20/32

(52) U.S. Cl. 705/72

(57) ABSTRACT

The present disclosure relates to a system and method for a secure payment. More, specifically the present disclosure relates to an automated method for enhanced security at point-of-sale (POS) terminals, cash machines (ATMs), or other similar electronic transfer devices during financial electronic transactions. The method includes receiving a request for an xPIN by a mobile device via a mobile gateway, sending the xPIN via the mobile gateway to the mobile device, receiving a transaction request at a transaction means for authorization and an xPIN verification request an interface, verifying the xPIN via the mobile gateway; and authorizing the transaction via the interface.

### CROSS-REFERENCE TO RELATED APPLICATIONS

The present non-provisional utility application claims priority under 35 U.S.C. §119(e) to co-pending provisional application no. U.S. 61/490,634 filed on May 27, 2011, which is hereby incorporated by reference in its entirety herein.

### BACKGROUND

The present invention relates to a system and method for a secure transaction system. More specifically, the system and method described herein relate to increasing electronic transaction security when using personal identification number (PIN)-based devices like Point of Sale (POS) terminals or cash machines (e.g., ATMs).

The security and reliability of data and information are fundamental factors in the digital world. As more and more consumers partake in the digital world, damage caused from skimming (the theft of credit card information used during a legitimate transaction) and hacking credit card and/or debit card information and associated PINs during electronic transactions is steadily escalating. The secure and accurate identification of a consumer using credit cards and/or debit cards is an essential part of electronic transactions, such as making payments at a POS terminal, withdrawing or depositing funds at an ATM, or transferring funds at a personal computer. Traditionally, the identification of a consumer using a credit card is made in person (e.g., a banker identifies a customer), but as electronic transactions (e.g., Internet banking, online payment, telephone banking, ATMs, and POS terminals) become more prevalent, the accurate and secure identification of consumers using credit cards and/or debit cards for electronic transactions is becoming increasingly difficult.

Currently, to consummate a secure identification during an electronic transaction, most POS machines and self-service machines (e.g., an ATM) use a system and method that utilizes possessive identification (e.g., possessing an identification card such as a debit card) and cognitive identification (e.g., possessing a PIN or executing a signature). The combination of these identifiers has allowed a consumer to quickly and securely consummate secure electronic payment transactions.

As technology advances, however, this multi-layer method of identification is becoming less secure. For instance, spying on consumers to obtain credit card information and PINs at the ATM is becoming more prevalent, and may be attributed to the miniaturization of cameras, for example. Moreover, because the foregoing system and method of secure identification requires a consumer to utilize his/her identification card (possessive identification) and his/her PIN (cognitive identification) at the same POS machine or self-service machine, spying and skimming are becoming relatively simple.

### SUMMARY

The present disclosure provides a system and a method that allows consumers to replace memorized static PINs required for the use of their debit and/or credit cards with a dynamic PIN that is valid only for a limited number of transactions or a limited period of time. This will both reduce and prevent successful skimming and hacking of consumers' PINs. In one embodiment, this is achieved by delivering a dynamic PIN to a mobile device for one time use. In the context of this disclosure, this PIN can be referred to as an xPIN, and it can be used at various POS terminals or ATMs utilizing Encrypted PIN Pad (EPP) devices (e.g., a keypad at an ATM device). While skimming of the xPIN at the PIN entry device (using an EPP) may not be directly prevented, the value of skimming will be greatly reduced because of the limited validity of the xPIN.

Described herein is a system and method for a secure payment. In one embodiment, a secure transaction system is disclosed. The system includes a mobile connection means for receiving a request for an xPIN from a mobile device and sending the xPIN to the mobile device. The system also includes an xPIN generation means for generating the xPIN. The system additionally includes an interface to connect the secure transaction system with PIN-based transaction devices. Further, the system includes an xPIN verification means for verifying a transaction request and an authorization means for authorizing the transaction request.

In a second embodiment a method for a secure transaction with a secure transaction system is disclosed. The method includes receiving a request for an xPIN by a mobile device via a mobile gateway and sending the xPIN via the mobile gateway to the mobile device. The method also includes receiving a transaction request at a transaction means for authorization and an xPIN verification request via an interface. Further, the method includes verifying the xPIN via the mobile gateway. The method yet further includes authorizing the transaction via the interface.

Also disclosed herein is a non-transitory computer readable medium with stored instructions. The stored instructions may be executable by a computing device to cause the computing device to perform functions including receiving a request for an xPIN by a mobile device via a mobile gateway and sending the xPIN via the mobile gateway to the mobile device. The functions also include receiving a transaction request at a transaction means for authorization and an xPIN verification request via an interface. The functions additionally include verifying the xPIN via the mobile gateway. The functions further include authorizing the transaction via the interface.

### BRIEF DESCRIPTION OF THE DRAWINGS

FIG. 1 is a schematic diagram illustrating a PIN based system for executing a secure electronic transaction.

FIG. 2 illustrates a schematic diagram of a system for executing a secure electronic transaction, according to an example embodiment of the present disclosure.

FIG. 3 illustrates a block diagram of a method for executing a secure electronic transaction, according to an example embodiment of the present disclosure.

FIG. 4 illustrates a block diagram of a computer program product that includes a computer program for executing a computer process on a computing device, arranged according to an example embodiment of the present disclosure.

### DETAILED DESCRIPTION

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

Several techniques exist to facilitate the identification of a consumer executing a secure electronic financial transaction. Biometrics are considered one secure technique. For example, fingerprint scans, facial scans, iris scans, and a venous scan, have all been established as secure identification techniques.

In another identification technique, the signature of a customer may be verified. For example, consumers may be required to provide proof of signature on the back of their credit card or debit card or the proof of signature may be stored electronically and associated with the card. Such proof of signature can be compared with a signature executed by the user to authorize an electronic transaction. While this identification method is still widely used, it is relatively easy to imitate the user's signature on the back of a card, which may be difficult to confirm especially in the hectic pace of daily transactions.

With current advances in technology, the possibility of evaluating a consumer for authentication (e.g., securely and accurately identifying a consumer during a payment or other financial transaction) by using his/her mobile device is becoming more feasible. However, authentication via a mobile device still has various unanswered technical and data protection issues. Accordingly, even if a consumer's use of physical credit cards and debit cards are replaced with microchips or mobile device applications (e.g., a smartphone application), the need for an additional verification may still be desirable. Moreover, it remains desirable to utilize techniques that employ a combination of possession identification and cognitive identification because there is already an existing infrastructure to execute these techniques and such techniques are already well accepted by the general population. Accordingly, a system and a method that uses the existing infrastructure or infrastructure developed in the future, but more safely and reliably authenticates consumers' electronic financial transactions is contemplated by the present disclosure.

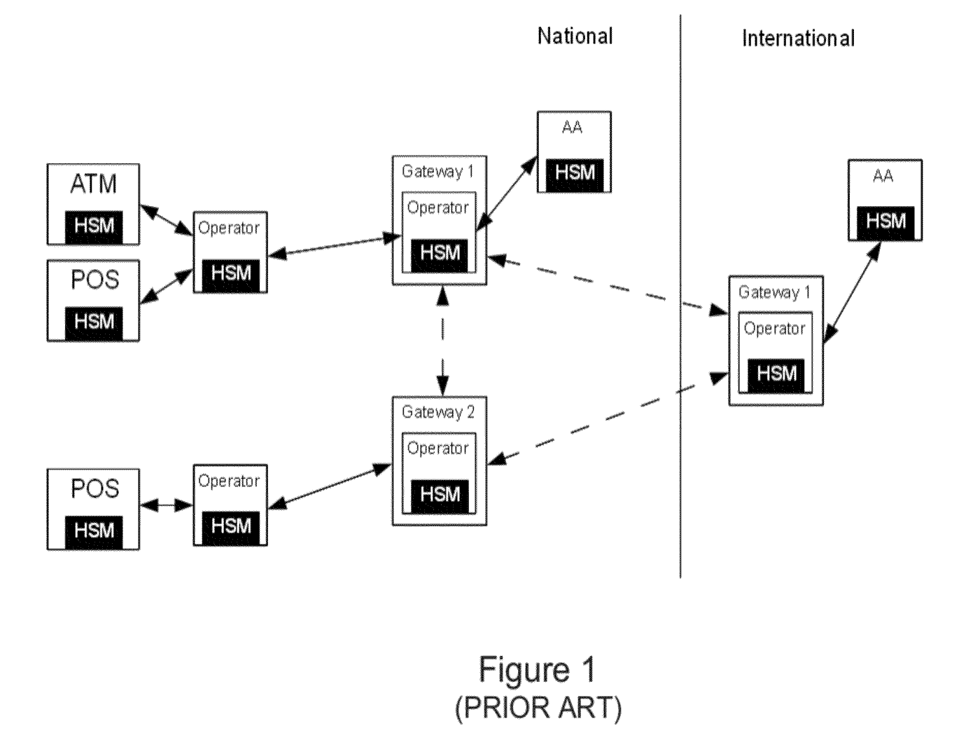

FIG. 1 is a schematic diagram illustrating an example embodiment of a PIN-based electronic financial transaction system that is known in the art. In FIG. 1, the identification of an authorized user at transaction points (e.g., ATM or POS terminals) is supported by the combination of possessive identification and cognitive identification (e.g., possessing a credit card or debit card and entering a PIN or signature). In one example, a PIN is entered in an EPP device associated with the transaction point and the PIN and an authorization request are transferred from the ATM or POS terminal in an encrypted message to an operator or authorization system for the terminal. The PIN and authorization request can be transferred either directly or indirectly by first passing through a relevant headend or gateway to be sent to a relevant Authorization Authority (AA), which is most often the card-issuing bank or financial institution of the credit card or debit card holder.

Intermediate bodies, such as network operators and gateways, implement, in accordance with national and international guidelines, message or data transfers, PIN re-mastering, data encryption, decryption, and/or re-encryption, and/or other functions. These functions may be carried out using a Hardware Security Module (HSM) associated with the network operators or gateways, for example. Generally, an HSM includes an input/output device for the efficient and secure execution of cryptographic operations. The AA decides which electronic transactions to execute or authorize for execution based on the information contained in the authorization request (e.g., the correct PIN, transaction type, payee, payor, account number, and authorization amount).

According to the present disclosure, by employing a configuration as described herein, it becomes possible for a consumer or cardholder to execute a more secure and reliable electronic financial transaction.

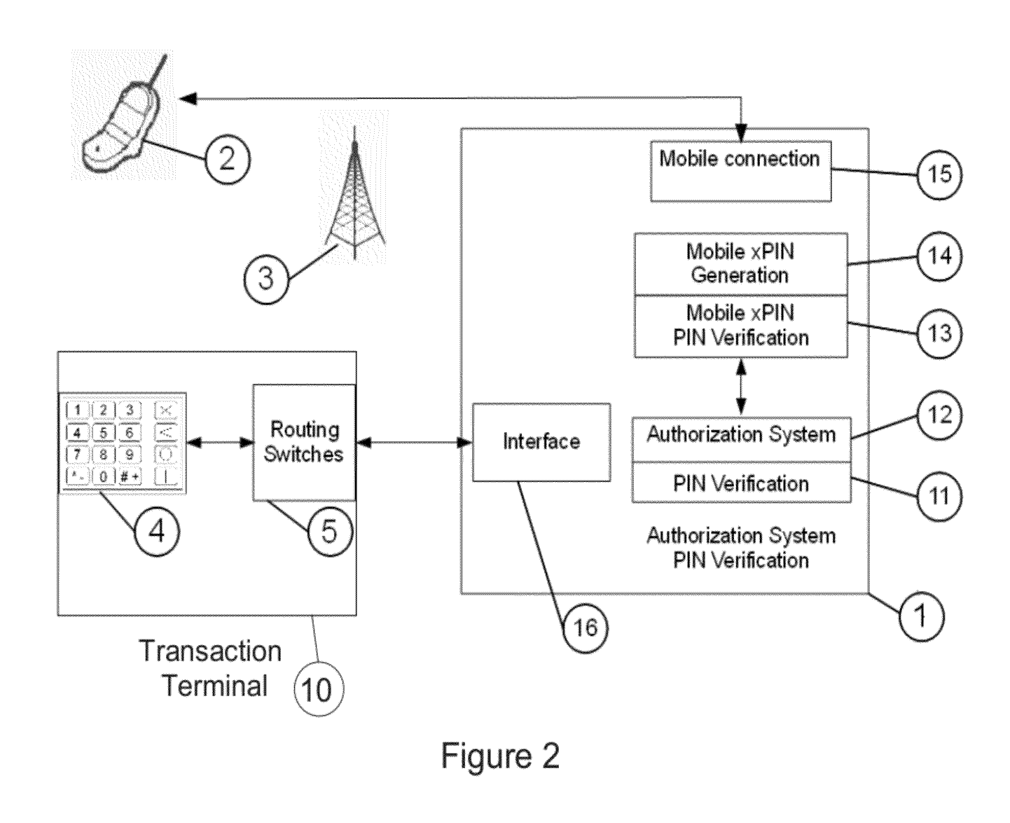

FIG. 2 illustrates a schematic diagram of a system for executing a secure financial transaction, according to an example embodiment. The system of FIG. 2 includes a mobile gateway or secure payment system 1, which in the present example can be a data storing and processing center configured to authorize electronic transactions at a transaction terminal 10 between a consumer, the consumer's financial institution, and potentially a third party. Generally, this authorization for electronic transactions is based, at least in part, on a PIN verification process. More particularly, the mobile gateway 1 can be utilized to authorize an electronic transaction at the transaction terminal 10 by communicating with a mobile device 2 through a connection tower 3 or other communication connection. In various examples, the transaction terminal may include an ATM, a POS terminal, a computing device through which Internet transactions are made, and the like. In more particular examples, the computing device can be a laptop or a mobile device 2 capable of executing Internet or mobile transactions.

In the present example, the mobile gateway 1 includes a PIN verification module 11, an authorization system module 12, a mobile xPIN PIN verification module 13, a mobile xPIN generation module 14, and a mobile connection module 15. Further, the transaction terminal 10 of FIG. 2 includes an EPP 4 and a routing switch 5. In one example, the EPP 4 includes a keypad for entering a PIN at ATMs, POS terminals, transfer terminals, or any other transaction terminal. The mobile device 2 may be any device that is capable of communicating with the mobile gateway 1 using a wired connection or a wireless protocol, for example. In FIG. 2, the connection tower 3 facilitates the wireless communication between the mobile device 2 and the mobile gateway 1. This wireless communication can be an internet protocol based communication or a wireless protocol, such as GSM, for example.

In another embodiment, various software and/or hardware components may be used to facilitate the execution of secure electronic transactions. For example, payment gateway (e.g., mobile gateway 1) functionalities may be used in conjunction with transaction authentication numbers (TANs) to execute one or more secure electronic transactions. The TAN may be communicated in the form of a message, for example, using Short Messaging Service (SMS) to the payment gateway for authorization. The payment gateway may be an e-commerce application service provider that authorizes payments for e-businesses, online retailers, bricks and clicks (online and offline businesses), or brick and mortar (traditional physical businesses). Accordingly, various aspects of a payment gateway may also be used to analyze, process, compute, and/or otherwise execute a secure electronic transaction. The TAN may represent a form of single use one-time passwords to authorize financial transactions. TANs are a second layer of security above and beyond the traditional single-password authentication.

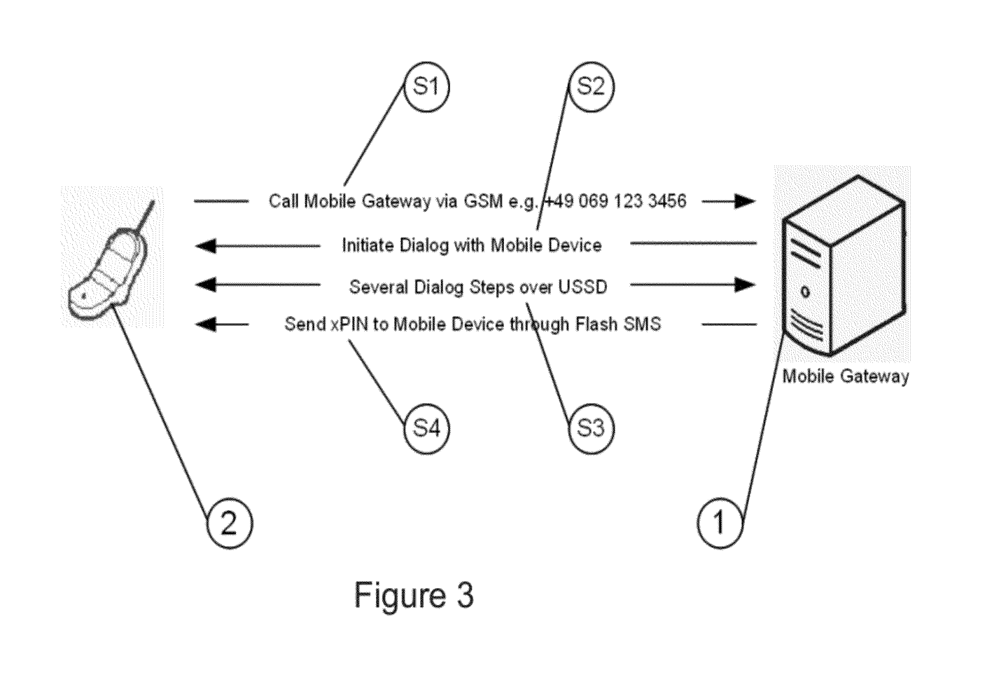

Referring now to FIG. 3, and with further reference to FIG. 2, in an example method of the present disclosure, before a card for an electronic transaction at a transaction terminal is used, at step S1 of FIG. 3, the cardholder requests a PIN from the mobile gateway 1 via the mobile device 2. Generally, the use of the card for an electronic transaction may include the physical insertion or swipe of the card in a card reader of the transaction terminal or the entry or selection of the card number and/or other account information associated with the card. Thus, the present systems and methods disclosed herein can be used for Internet and other “card-less” transactions. The mobile device 2 may be a smartphone or a cell phone registered to the cardholder, for example. Within the context of the present disclosure, the PIN requested using the mobile device is also referred to as an xPIN that is valid only for a limited number of transactions, such as for only the next transaction, or only for a limited amount of time, such as for the next ten minutes. To request the PIN from the secure payment system 1, at step S1, the consumer or cardholder can call a service number of the card-issuing institution to connect to the mobile gateway 1 through the mobile connection module 15. In one example, once the call is established, the call is registered by the mobile gateway 1 and the call is automatically cancelled. Thus, the consumer can avoid any phone call usage charges for requesting the PIN.

Next, at step S2, the mobile gateway 1 (through the mobile connection module 15) initiates a dialogue with the mobile device 2. The dialogue between the mobile gateway 1 and the mobile device 2 can be initiated through an unstructured supplementary service data (USSD) dialogue. Generally, USSD is a bearer service for GSM-based cellular networks defined by the standards GSM 02.90, GSM 03.90, and GSM 04.90. Through USSD, conventional communication with the mobile device 2 is possible without connecting the mobile gateway 1 and the mobile device 2 through a phone call. In some embodiments, the mobile gateway 1 may determine that the dialogue with the mobile device 2 was correctly initiated by validating a specific hardware address of the mobile device 2 by matching a stored International Mobile Equipment Identity (IMEI) on the mobile device with another IMEI stored in an external database of the mobile gateway. After the dialogue has been initiated, the mobile gateway 1, at step S3, can perform one or more of the following functions or processes: (1) prompt the mobile device 2 for an authentication code; (2) query the consumer as to which card (e.g., by card number, account number, or some other card identifier) an xPIN is being requested for; and (3) terminate the dialogue between the mobile gateway 1 and the mobile device 2. At times, the dialogue may not be successfully initiated. In that case, the mobile gateway 1 can attempt to initiate the dialogue at any later time to generate a new xPIN as necessary.

In one example, prompting the mobile device 2 for an authentication code and/or querying the consumer for a credit/debit card (if an xPIN can be requested for more than one card) includes the mobile gateway 1 sending a message to the mobile device using SMS. In response, the consumer may reply using SMS and provide an authorization code and/or indicate which card an xPIN is being requested for by entering a card identification number or other identifier using the mobile device 2. Once the consumer has identified the card requesting an xPIN, the dialogue can be terminated by the mobile gateway 1.

In another example embodiment, during step S3, the mobile gateway 1 may not prompt the mobile device 2 for an authentication code. This step can be omitted based on a decision of the bank at which the mobile gateway 1 is located, for example. For instance, the mobile device 2 can be authenticated merely be comparing the mobile phone number to a registered phone number associated with a consumer.

Once the dialogue has been terminated, at step S4, the mobile gateway 1 generates an xPIN using a random number generator or some other known technique, encrypts or blocks the xPIN, and sends the encrypted or blocked xPIN to the mobile device 2. The xPIN may be sent via SMS, email, or any other suitable method. In another embodiment, additional data or information can be sent along with the xPIN, for instance, marketing, advertising, or account bonus system messages can be sent to the mobile device 2 via SMS, email, or any other suitable method. In yet another embodiment, if a POS or ATM is located at a site where there is no LAN or WiFi signal, the xPIN can be obtained at a remote location. Alternatively, the consumer's static PIN can be used to authorize the transaction. Further, once the xPIN has been received or at some time before the xPIN has been received, the consumer can indicate how long the xPIN should be valid, for example, for only the next transaction or for the next ten minutes. Once the consumer receives the xPIN at the mobile device 2, the consumer can use the xPIN to authorize a transaction at the transaction terminal 10. For example, the consumer may receive a SMS message with an xPIN on his/her mobile device 2 and use that xPIN at an ATM (transaction terminal 10) via the ATM's pin pad (EPP 4) to execute an electronic transaction.

In another embodiment, the xPIN may be obtained or otherwise received via an application program executed by the mobile device 2. Additionally, the application executed by the mobile device 2 may initiate and conduct the dialogue (e.g., USSD) between the mobile phone 2 and the mobile gateway 1, for example.

After the consumer enters the xPIN to authorize the transaction via the EPP 4 of the transaction terminal 10, the mobile gateway 1, which communicates with the consumer's bank, executes processes to authorize the requested transaction. For example, if a consumer receives an xPIN at his/her mobile device and uses that xPIN at the EPP 4 to authorize a transaction of a payment of one thousand dollars, the mobile gateway 1 will authorize the payment of one thousand dollars once the xPIN has been verified. Verification of the xPIN entered at the EPP 4 is performed by the mobile xPIN PIN verification module 13 of the mobile gateway 1, such as by utilizing specialized HSMs.

Illustratively, the xPIN entered at the EPP 4 can be blocked or encrypted and sent from a routing switch 5 associated with the transaction terminal 10 to an interface 16 of the mobile gateway 1. The blocked xPIN can then be transmitted to the xPIN PIN verification module 13 to be compared to a stored, valid, and perhaps blocked xPIN to find a match to verify the consumer and authorize the transaction. The xPIN PIN verification module 13 also determines whether an authorization request for the xPIN has been promoted before to determine whether the xPIN is still valid. More particularly, if the xPIN has been used to authorize a transaction request more than the set number of times (e.g., more than one time) or is being used beyond a pre-defined period of time (e.g., more than ten minutes), then the xPIN PIN verification module 13 determines that the xPIN is no longer valid and the mobile gateway 1 denies the authorization request. Otherwise, if the blocked xPIN entered at the EPP 4 matches a valid xPIN, then the mobile gateway 1 will authorize the transaction. Once the transaction is authorized using the xPIN, the xPIN PIN verification module 13 can tag the xPIN as being used, which may then cause the xPIN to become invalid for future authorization requests. Such an invalid xPIN can then be deleted.

In another example embodiment, the mobile gateway 1 may be expanded by an additional PIN verification executed by the PIN verification module 11. More particularly, because the mobile gateway 1 may not know whether the transmitted xPIN is equivalent to the original PIN associated with a user's card (which is still valid), or the generated xPIN, first the existing PIN verification is carried out by the PIN verification module 11. If the PIN is confirmed as invalid, an additional PIN verification can be executed by the xPIN PIN verification module 13, as described above. If this additional verification is successful against the xPIN, the transaction request is authorized.

After the transaction request is authorized and the transaction completed, another message can be sent to the mobile device 2 as confirmation of the completed transaction. Such message can be sent via SMS or any other suitable method.

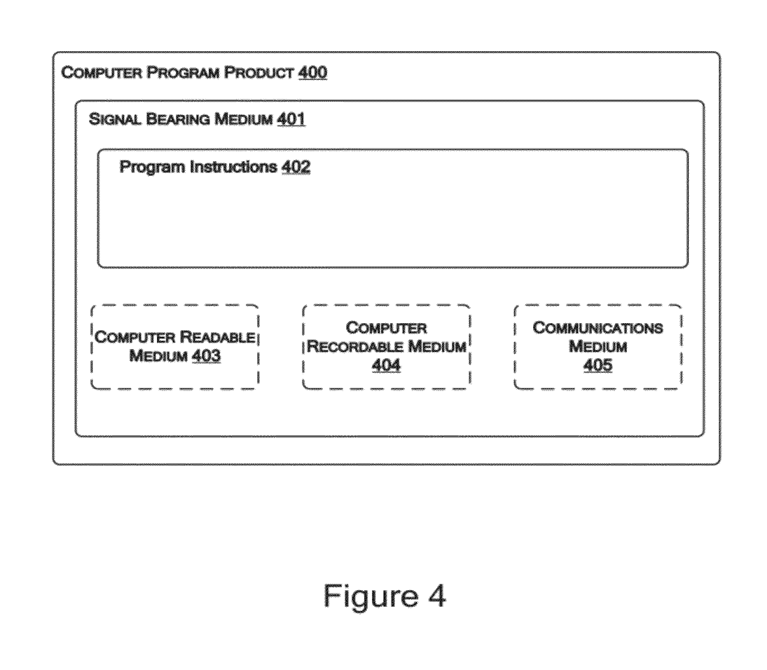

FIG. 4 is a schematic illustrating a conceptual partial view of an example computer program product that includes a computer program for executing a computer process on a computing device, arranged according to at least some embodiments presented herein.

In one embodiment, a computer program product 400 is provided using a signal bearing medium 401. The signal bearing medium 401 may include one or more programming instructions 402 that, when executed by one or more processors may provide functionality or portions of the functionality described above with respect to FIGS. 1-3. For example, the signal bearing medium may perform functions that allow a consumer to execute a secure electronic transaction with a mobile device, as described herein. In some examples, the signal bearing medium 401 may encompass a computer-readable medium 403, such as, but not limited to, a hard disk drive, a Compact Disc (CD), a Digital Video Disk (DVD), a digital tape, memory, etc. In some implementations, the signal bearing medium 401 may encompass a computer recordable medium 404, such as, but not limited to, memory, read/write (R/W) CDs, R/W DVDs, etc. In some implementations, the signal bearing medium 401 may encompass a communications medium 405, such as, but not limited to, a digital and/or an analog communication medium (e.g., a fiber optic cable, a waveguide, a wired communications link, a wireless communication link, etc.). Thus, for example, the signal bearing medium 401 may be conveyed by a wireless form of the communications medium 405 (e.g., a wireless communications medium conforming with the IEEE 802.11 standard or other transmission protocol).

The one or more programming instructions 402 may be, for example, computer executable and/or logic implemented instructions. In some examples, a computing device such as the computing device 400 of FIG. 4 may be configured to provide various operations, functions, or actions in response to the programming instructions 402 conveyed to the computing device 400 by one or more of the computer readable medium 403, the computer recordable medium 404, and/or the communications medium 405.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A secure transaction system comprising:
a mobile connection means for receiving a request for an xPIN from a mobile device and sending the xPIN to the mobile device;
an xPIN generation means for generating the xPIN;
an interface to connect the secure transaction system with PIN-based transaction devices;
an xPIN verification means for verifying a transaction request; and
an authorization means for authorizing the transaction request.

2. The secure transaction system of claim 1, further comprising an automated dialogue initiating and terminating means for initiating a dialogue with the mobile device, wherein the automated dialogue initiating and terminating means prompts the mobile device for an authentication code, queries the mobile device for a card identification number, and terminates the dialogue with the mobile device.

3. The secure transaction system of claim 2, further comprising a means for registering a call from the mobile device and a terminating means for automatically terminating the call from the mobile device once registered.

4. The secure transaction system of claim 3, further comprising a control means for verifying an encrypted PIN.

5. The secure transaction system of claim 4, further comprising a security means for validating a specific hardware address of the mobile device by matching a stored International Mobile Equipment Identity (IMEI) on the mobile device with another IMEI stored in an external database.

6. The secure transaction system of claim 1, further comprising a mobile connection means for sending the xPIN via SMS to the mobile device.

7. The secure transaction system of claim 1, wherein the xPIN comprises a PIN code used for debit and credit cards.

8. A method for a secure transaction with a secure transaction system comprising:
receiving a request for an xPIN by a mobile device via a mobile gateway;
sending the xPIN via the mobile gateway to the mobile device;
receiving a transaction request at a transaction means for authorization and an xPIN verification request via an interface;
verifying the xPIN via the mobile gateway; and
authorizing the transaction via the interface.

9. The method of claim 8, wherein receiving the request for the xPIN by the mobile device via the mobile gateway further comprises:
determining an identity of a caller and terminating a call;
initiating a dialogue with the mobile device;
prompting the mobile device for an authentication code;
querying the mobile device for card identification information; and
terminating the dialogue with the mobile device.

10. The method of claim 8, wherein verifying the xPIN comprises:
determining whether the xPIN is equal to a static PIN dedicated to a particular card;
when the xPIN is not equal to the static PIN, forwarding an encrypted xPIN to a PIN verification means to determine the validity of the xPIN; and
when the xPIN Block has not been submitted more than a pre-determined number of times and when a pre-defined period-of-time relating to the xPIN has not expired, accepting the xPIN to authorize the secure transaction.

11. The method of claim 10, wherein accepting the xPIN to authorize the secure transaction comprises:
tagging the requested xPIN in a manner so as to indicate the xPIN has been previously used.

12. A non-transitory computer readable medium having stored therein instructions executable by a computer system to cause the computer system to perform the functions comprising:
receiving a request for an xPIN by a mobile device via a mobile gateway;
sending the xPIN via the mobile gateway to the mobile device;
receiving a transaction request at a transaction means for authorization and an xPIN verification request via an interface;
verifying the xPIN via the mobile gateway; and
authorizing the transaction via the interface.

13. The non-transitory computer readable medium of claim 12, wherein the functions further comprise:
determining an identity of a caller and terminating a call;
initiating a dialogue with the mobile device;
prompting the mobile device for an authentication code;
querying the mobile device for a card identification information; and
terminating the dialogue with the mobile device.

14. The non-transitory computer readable medium of claim 12, wherein verifying the xPIN further comprises:
determining whether the xPIN is equal to a static PIN dedicated to a particular card;
when the xPIN is not equal to the static PIN, forwarding an encrypted xPIN to a PIN verification means to determine the validity of the xPIN; and
when the xPIN Block has not been submitted more than a pre-determined number of times and when a pre-defined period-of-time relating to the xPIN has not expired, accepting the xPIN to authorize the secure transaction.

15. The non-transitory computer readable medium of claim 14, wherein accepting the xPIN to authorize the secure transaction further includes tagging the requested xPIN in a manner so as to indicate the xPIN has been previously used.
